(19) United States
(12) Patent Application Publication
(10) Pub. No.: US 2024/0412390 A1
(43) Pub. Date: Dec. 12, 2024

(54) METHOD AND ELECTRONIC SYSTEM FOR IMAGE ALIGNMENT

(71) Applicant: MEDIATEK INC., Hsinchu City (TW)

(72) Inventors: Yen-Yang CHOU, Hsinchu City (TW); Keh-Tsong LI, Hsinchu City (TW); Shao-Yang WANG, Hsinchu City (TW); Chia-Hui KUO, Hsinchu City (TW); Hung-Chih KO, Hsinchu City (TW); Pin-Wei CHEN, Hsinchu City (TW); Yu-Hua HUANG, Hsinchu City (TW); Yun-I CHOU, Hsinchu City (TW); Chien-Ho YU, Hsinchu City (TW); Chi-Cheng JU, Hsinchu City (TW); Ying-Jui CHEN, Hsinchu City (TW)

(21) Appl. No.: 18/331,416

(22) Filed: Jun. 8, 2023

(51) Int. Cl. G06T 7/33; G06T 3/00; H04N 5/265

(52) U.S. Cl. CPC G06T 7/337; G06T 3/04; H04N 5/265; G06T 2207/20221

(57) ABSTRACT

A method for image alignment is provided. The method for image alignment includes the following stages. A first image with a first property from a first sensor is received. A second image with a second property from a second sensor is received. The first property is similar to the second property. The first feature correspondence between the first image and the second image is calculated. A third image with a third property from the first sensor and a fourth image with a fourth property from the second image sensor are received. The third property is different from the fourth property. Image alignment is performed on the third image and the fourth image based on the first feature correspondence between the first image and the second image.

### BACKGROUND OF THE INVENTION

### Field of the Invention

The present invention relates to an image processing method, and, in particular, to a method and an electronic system for image alignment.

### Description of the Related Art

Multi-camera image fusion (image fusion) technology provides an image that synthesizes the information we are interested in in each image. For multi-camera image fusion, it is necessary to obtain the feature correspondence between each image first, and then perform image alignment on images with different viewing angles, and then superimpose the aligned multiple images.

However, due to the requirements of different settings or characteristics between cameras (such as superposition of images with different “exposure time” or “receiving spectrum”), the characteristics of the same object vary greatly between images. In the process of finding corresponding features, the high probability of feature matching fails, and the alignment effect is not good, which leads to a poor fusion image effect.

### BRIEF SUMMARY OF THE INVENTION

An embodiment of the present invention provides a method for image alignment. The method for image alignment includes the following stages. A first image with a first property from a first sensor is received. A second image with a second property from a second sensor is received. The first property is similar to the second property. The first feature correspondence between the first image and the second image is calculated. A third image with a third property from the first sensor and a fourth image with a fourth property from the second image sensor are received. The third property is different from the fourth property. Image alignment is performed on the third image and the fourth image based on the first feature correspondence between the first image and the second image.

According to the method described above, the first property represents a first spectrum range of the first image. The second property represents a second spectrum range of the second image. The second spectrum range is similar to the first spectrum range.

According to the method described above, the third property represents a third spectrum range of the third image. The fourth property represents a fourth spectrum range of the fourth image. The third spectrum range is similar to the first spectrum range and different from the fourth spectrum range.

According to the method described above, the first image and the second image are received earlier than the third image and the fourth image.

The method for image alignment further includes the following stages. The first feature correspondence between the first image and the second image is stored into a warping map.

According to the method described above, the warping map records the first displacement vector of each pixel between the first image and the second image.

The method for image alignment further includes the following stages. The third image is compared with the first image to obtain a comparison result. It is determined whether to perform image alignment on the third image and the fourth image based on the first feature correspondence according to the comparison result.

According to the method described above, the comparison result indicates that the third image matches the first image, or the third image does not match the first image.

According to the method described above, if the third image does not match the first image, the method further includes the following stages. A second feature correspondence between the third image and the fourth image is calculated. Image alignment is performed on the third image and the fourth image based on the second feature correspondence between the third image and the fourth image.

According to the method described above, the step of calculating the first feature correspondence between the first image and the second image includes the following stages. Feature extraction is performed on each pixel in the first image and the second image to obtain respective pixel features. Feature matching is performed between each pixel in the first image and each pixel in the second image to obtain the first displacement vector.

According to the method described above, the step of performing feature matching between each pixel in the first image and each pixel in the second image includes the following stages. The position of the pixel features in the first image corresponding to the pixel features with the highest similarity in the second image is searched for and recorded. The first displacement vector is generated according to the position of the pixel features in the first image corresponding to the pixel features with the highest similarity in the second image.

According to the method described above, the pixel features include brightness, color, and texture.

According to the method described above, the step of performing image alignment on the third image and the fourth image based on the first feature correspondence between the first image and the second image includes the following stages. A warping function is generated according to the pixel features in both the first image and the second image with the highest discrimination and the highest similarity. The third image or the fourth image is input into the warping function to perform image alignment between the third image and the fourth image.

According to the method described above, the step of performing image alignment on the third image and the fourth image based on the first feature correspondence between the first image and the second image includes the following stages. The position of each pixel in the third image is converted to the position of each pixel in the fourth image through the first displacement vector to perform image alignment between the third image and the fourth image.

The method for image alignment further includes the following stages. The second feature correspondence between the third image and the fourth image is stored into a warping map. Image fusion is performed on the third image and the fourth image after the image alignment to output a fusion image.

An embodiment of the present invention provides an electronic system. The electronic system includes a first sensor, a second sensor, and a processor. The first sensor outputs a first image and a third image according to a first property. The second sensor outputs a second image according to the first property and output a fourth image according to a second property. The second property is different from the first property. The processor performs the following stages. The first image from the first sensor is received. The second image from the second sensor is received. A first feature correspondence between the first image and the second image is calculated. The third image from the first sensor and the fourth image from the second sensor are received. Image alignment is performed on the third image and the fourth image based on the first feature correspondence between the first image and the second image.

According to the electronic system described above, the time at which the processor receives the first image and the second image is earlier than the time at which the processor receives the third image and the fourth image.

According to the electronic system described above, the processor stores the first feature correspondence between the first image and the second image into a warping map.

According to the electronic system described above, the warping map records a first displacement vector of each pixel between the first image and the second image.

### BRIEF DESCRIPTION OF THE DRAWINGS

The present invention can be more fully understood by reading the subsequent detailed description and examples with references made to the accompanying drawings, wherein:

FIG. 1 is a flow chart of a method for image alignment in accordance with some embodiments of the present invention.

FIG. 2 is a flow chart of a method for image alignment in accordance with some embodiments of the present invention.

FIG. 3A is a detail flow chart of step S104 of the method for image alignment in FIG. 1 in accordance with some embodiments of the present invention.

FIG. 3B is a detail flow chart of step S208 of the method for image alignment in FIG. 2 in accordance with some embodiments of the present invention.

FIG. 4A is a detail flow chart of step S302 of the method for image alignment in FIG. 3A in accordance with some embodiments of the present invention.

FIG. 4B is a detail flow chart of step S306 of the method for image alignment in FIG. 3B in accordance with some embodiments of the present invention.

FIG. 5 is a schematic diagram of steps S400 and S402 in FIG. 4A in accordance with some embodiments of the present invention.

FIG. 6A is a detail flow chart of step S108 of the method for image alignment in FIG. 1 in accordance with some embodiments of the present invention.

FIG. 6B is a detail flow chart of step S108 of the method for image alignment in FIG. 1 in accordance with some embodiments of the present invention.

FIG. 7A is a schematic diagram of steps S600 and S602 in FIG. 6A in accordance with some embodiments of the present invention.

FIG. 7B is a schematic diagram of step S604 in FIG. 6B in accordance with some embodiments of the present invention.

FIG. 8 is a schematic diagram of an electronic system 800 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” and/or “include” used in the present invention are used to indicate the existence of specific technical features, values, method steps, operations, units and/or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without departing from the spirit of the present invention.

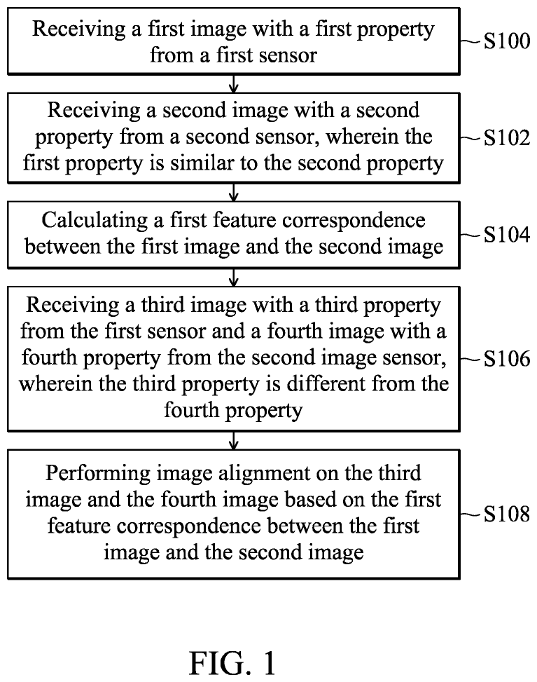

FIG. 1 is a flow chart of a method for image alignment in accordance with some embodiments of the present invention. As shown in FIG. 1, the method for image alignment of the present invention includes the following stages. A first image with a first property from a first sensor is received (step S100). A second image with a second property from a second sensor is received (step S102). The first property is similar to the second property. The first feature correspondence between the first image and the second image is calculated (step S104). A third image with a third property from the first sensor and a fourth image with a fourth property from the second image sensor are received (step S106). The third property is different from the fourth property. Image alignment is performed on the third image and the fourth image based on the first feature correspondence between the first image and the second image (step S108). In some embodiments, steps S100 to S104 are referred to a pre-calibration stage. Step S108 is performed based on the first feature correspondence calculated in the pre-calibration stage. In some embodiments, the first property represents a first spectrum range of the first image, and the second property represents a second spectrum range of the second image, wherein the second spectrum range is similar to the first spectrum range. In some embodiments, the third property represents a third spectrum range of the third image, and the fourth property represents a fourth spectrum range of the fourth image, wherein the third spectrum range is similar to the first spectrum range and different from the fourth spectrum range.

In some embodiments, the first sensor in step S100 is a NIR sensor. The second sensor in step S102 is a RGB sensor with a replaceable filter, but the present invention is not limited thereto. The replaceable filter is able to let NIR pass through, so that the NIR is received by the second sensor. In some embodiments, the second sensor installs the replaceable filter in step S102. However, the second sensor does not install the replaceable filter in step S106. In some embodiments, the first spectrum in steps S100 and S102 is the NIR spectrum. The second spectrum in step S106 is the RGB spectrum. That is, the first image in step S100 and the second image in step S102 are the images received according to the NIR spectrum. The third image in step S106 is the image received according to the NIR spectrum. The fourth image in step S106 is the image received according to the RGB spectrum.

In some embodiments, the first image in step S100 and the second image in step S102 are the images received according to a long exposure time. The third image in step S106 is the image received according to the long exposure time. The fourth image in step S106 is the image received according to a short exposure time.

In some embodiments, the first sensor in step S100 is a main camera disposed at the same position as that in step S106. Similarly, the second sensor in step S102 is a sub camera disposed at the same position as that in step S106. The sub sensor is disposed near the main sensor, but the present invention is not limited thereto. In some embodiments, steps S100 and S102 are performed before step S106.That is, the first image and the second image are received earlier than the third image and the fourth image. In some embodiments, the method for image alignment of the present invention stores the first feature correspondence between the first image and the second image in step S104 into a warping map. The warping map records the first displacement vector of each pixel between the first image and the second image. In some embodiments, the method for image alignment of the present invention performs image fusion on the third image and the fourth image after step S108 to output a fusion image.

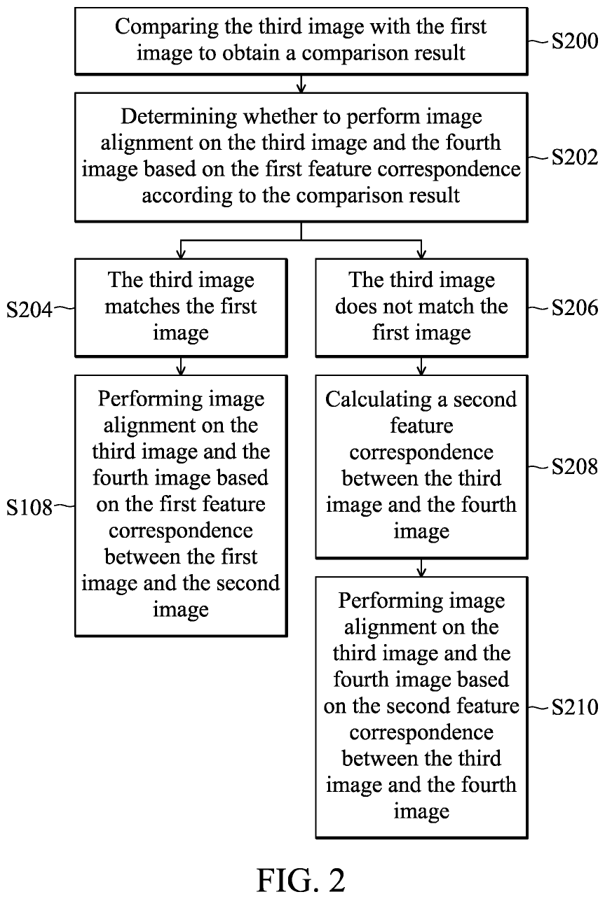

FIG. 2 is a flow chart of a method for image alignment in accordance with some embodiments of the present invention. As shown in FIG. 2, the method for image alignment of the present invention includes the following stages. The third image is compared with the first image to obtain a comparison result (step S200). It is determined whether to perform image alignment on the third image and the fourth image based on the first feature correspondence according to the comparison result (step S202). If the third image matches the first image (S204), step S108 in FIG. 1 is performed. If the third image does not match the first image (S206), a second feature correspondence between the third image and the fourth image is calculated (S208), and image alignment is performed on the third image and the fourth image based on the second feature correspondence between the third image and the fourth image (S210). In some embodiments, the method for image alignment of the present invention determines whether the third image matches the first image according to the pixel features in both the first and third images. In some embodiments, the pixel features include brightness, color, and texture, but the present invention is not limited thereto. For example, if there is a clean background in the first image, but there is an object (such as a person) disposed in the foreground in the third image, the method for image alignment of the present invention determines that the third image does not match the first image, so that the first correspondence in step S104 is not utilized to perform image alignment on the third image and the fourth image. In another embodiment, the first correspondence in step S104 is utilized to perform image alignment on a partial region of the third image and the fourth image. For example, in the same scenario that there is a clean background in the first image, but there is an object (such as a person) disposed in the foreground in the third image, the first correspondence in step S104 is utilized to perform image alignment for a first region corresponding to where the object is not disposed. Accordingly, a second feature correspondence between a second region corresponding to where the object is disposed in the third image and the fourth image is calculated (S208), and image alignment is performed on the second region in the third image and the fourth image based on the second feature correspondence between the third image and the fourth image (S210).

In contrast, the method for image alignment of the present invention utilizes the second feature correspondence between the third image and the fourth image in step S208 to perform image alignment on the third image and the fourth image. In some embodiments, the method for image alignment of the present invention stores the second feature correspondence between the third image and the fourth image in step S208 into a warping map. The warping map records a second displacement vector of each pixel between the third image and the fourth image. In some embodiments, the warping map is stored in a memory, but the present invention is not limited thereto. In some embodiments, steps S200 and S202 are performed after step S104 in FIG. 1, but the present invention is not limited thereto.

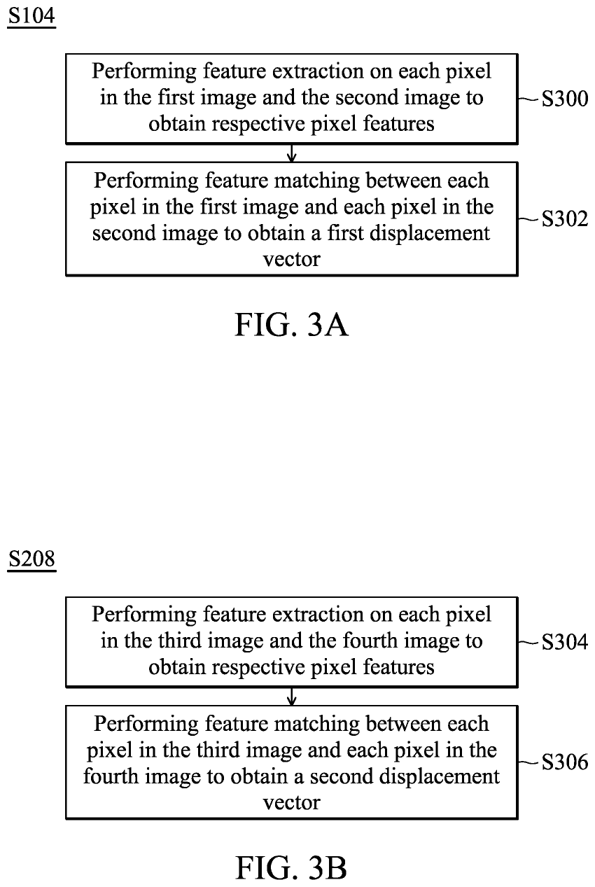

FIG. 3A is a detail flow chart of step S104 of the method for image alignment in FIG. 1 in accordance with some embodiments of the present invention. As shown in FIG. 3A, the method for image alignment of the present invention includes the following stages. Feature extraction is performed on each pixel in the first image and the second image to obtain respective pixel features (step S300). Feature matching is performed between each pixel in the first image and each pixel in the second image to obtain the first displacement vector (step S302). In some embodiments, step S300 and step S302 are performed no matter whether the third image matches the first image or not. FIG. 3B is a detail flow chart of step S208 of the method for image alignment in FIG. 2 in accordance with some embodiments of the present invention. As shown in FIG. 3B, the method for image alignment of the present invention includes the following stages. Feature extraction is performed on each pixel in the third image and the fourth image to obtain respective pixel features. Feature matching is performed between each pixel in the third image and each pixel in the fourth image to obtain a second displacement vector. In some embodiments, step S304 and step S306 are performed only when the third image does not match the first image.

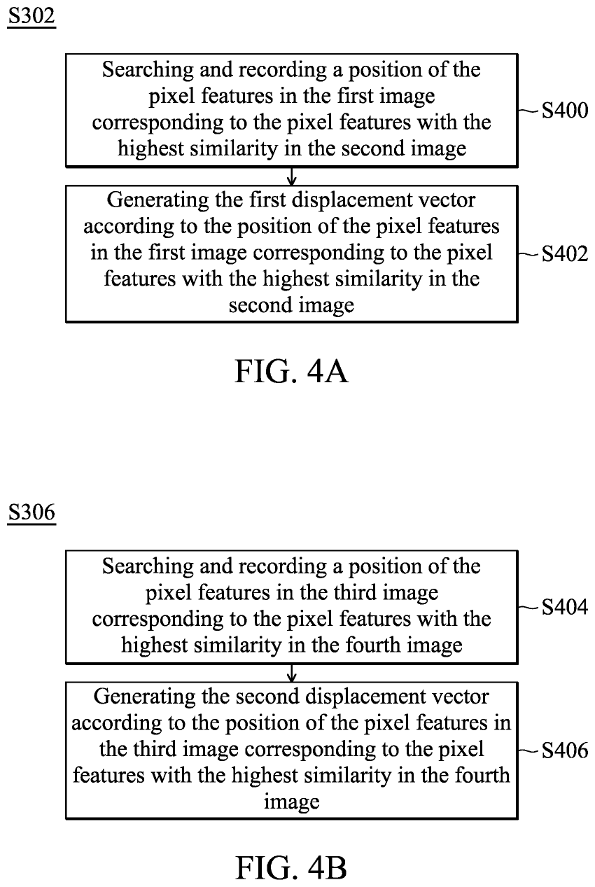

FIG. 4A is a detail flow chart of step S302 of the method for image alignment in FIG. 3A in accordance with some embodiments of the present invention. As shown in FIG. 4A, the method for image alignment of the present invention includes the following stages. The position of the pixel features in the first image corresponding to the pixel features with the highest similarity in the second image is searched for and recorded (step S400). The first displacement vector is generated according to the position of the pixel features in the first image corresponding to the pixel features with the highest similarity in the second image (step S402). Similarly, FIG. 4B is a detail flow chart of step S306 of the method for image alignment in FIG. 3B in accordance with some embodiments of the present invention. As shown in FIG. 4B, the method for image alignment of the present invention includes the following stages. The position of the pixel features in the third image corresponding to the pixel features with the highest similarity in the fourth image is searched for and recorded (step S404). The second displacement vector is generated according to the position of the pixel features in the third image corresponding to the pixel features with the highest similarity in the fourth image (step S406). In some embodiments, the pixel features include brightness, color, and texture, but the present invention is not limited thereto.

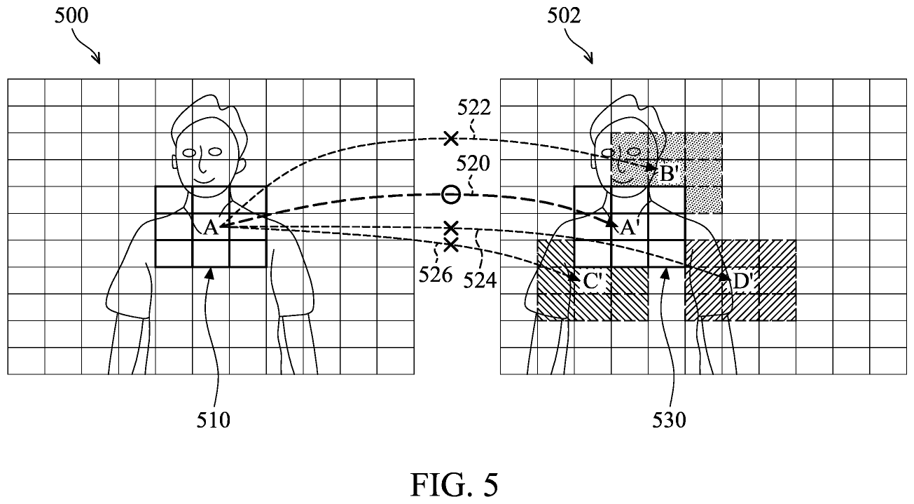

FIG. 5 is a schematic diagram of steps S400 and S402 in FIG. 4A in accordance with some embodiments of the present invention. As shown in FIG. 5, the method for image alignment of the present invention receives a first image 500 from the first sensor, and receives a second image 502 from the second sensor. In some embodiments, the first image 500 and the second image 502 are the images received according to the NIR spectrum, but the present invention is not limited thereto. The method for image alignment of the present invention performs feature extraction on each pixel in the first image and on each pixel in the second image to obtain respective pixel features. After that, taking the pixel features 510 in the first image 500 as an example, the method for image alignment of the present invention searches and records the position A of the pixel features 510 in the first image 500 corresponding to the pixel features 530 with the highest similarity in the second image 502. Similarly, the method for image alignment of the present invention also searches and records the position A′ of the pixel features 530 in the second image 502 corresponding to the pixel features 510 with the highest similarity in the first image 500. That is, the method for image alignment of the present invention determines that the pixel features 530 at the position A′ in the second image 502 have highest similarity with the pixel features 510 at the position A in the first image 500.

Then, the method for image alignment of the present invention generates the first displacement vector 520 according to the position A of the pixel features 510 in the first image 500 corresponding to the pixel features 530 with the highest similarity in the second image 502 and/or the position A′ of the pixel features 530 in the second image 502 corresponding to the pixel features 510 with the highest similarity in the first image 500. In some embodiments, the method for image alignment of the present invention determines that the corresponding pixel features at the position B′ in the second image 502 do not have highest similarity with the pixel features 510 at the position A in the first image 500, thus the method for image alignment of the present invention does not generate the displacement vector 522. In some embodiments, the method for image alignment of the present invention determines that the corresponding pixel features at the position C′ in the second image 502 do not have highest similarity with the pixel features 510 at the position A in the first image 500, thus the method for image alignment of the present invention does not generate the displacement vector 526. In some embodiments, the method for image alignment of the present invention determines that the corresponding pixel features at the position D′ in the second image 502 do not have highest similarity with the pixel features 510 at the position A in the first image 500, thus the method for image alignment of the present invention does not generate the displacement vector 524.

In some embodiments of FIG. 5, the pixel features 510 and the pixel features 530 in FIG. 5 include the pixel features from nine pixels respectively, but the present invention is not limited thereto. In some embodiments of FIG. 5, the position A of the pixel features 510 is the position of the center pixel of the nine pixels in the first image 500. The position A′ of the pixel features 530 is the position of the center pixel of the nine pixels in the second image 502, but the present invention is not limited thereto. In some embodiments, the first displacement vector 520 is used to provide the feature correspondence of the pixel features from each pixel between the first image 500 and the second image 502, but is not only limited to the pixel features 510 and the pixel features 530 in FIG. 5.

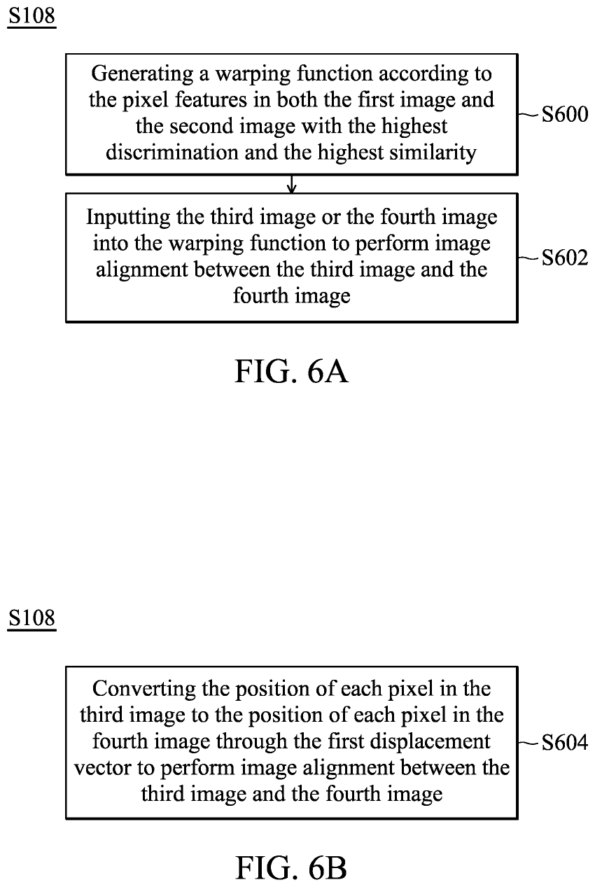

FIG. 6A is a detail flow chart of step S108 of the method for image alignment in FIG. 1 in accordance with some embodiments of the present invention. As shown in FIG. 6A, the method for image alignment of the present invention includes the following stages. A warping function is generated according to the pixel features in both the first image and the second image with the highest discrimination and the highest similarity (step S600). The third image or the fourth image is input into the warping function to perform image alignment between the third image and the fourth image (step S602). In some embodiments, the method for image alignment of the present invention performs steps S600 and S602 to finish the image alignment between the third image and the fourth image through an image-to-image conversion. FIG. 6B is a detail flow chart of step S108 of the method for image alignment in FIG. 1 in accordance with some embodiments of the present invention. As shown in FIG. 6B, the method for image alignment of the present invention includes the following stage. The position of each pixel in the third image is converted to the position of each pixel in the fourth image through the first displacement vector to perform image alignment between the third image and the fourth image (step S604). In some embodiments, the method for image alignment of the present invention performs step S604 to finish the image alignment between the third image and the fourth image through a pixel-to-pixel conversion.

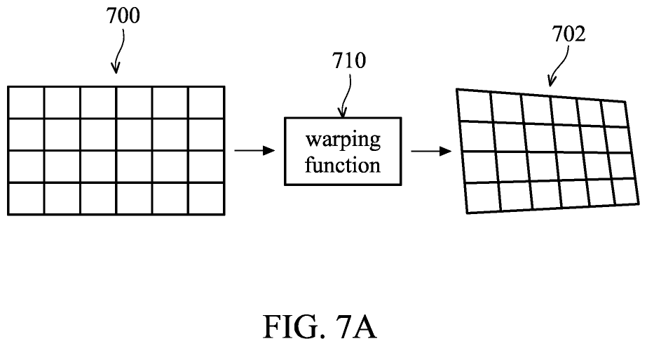

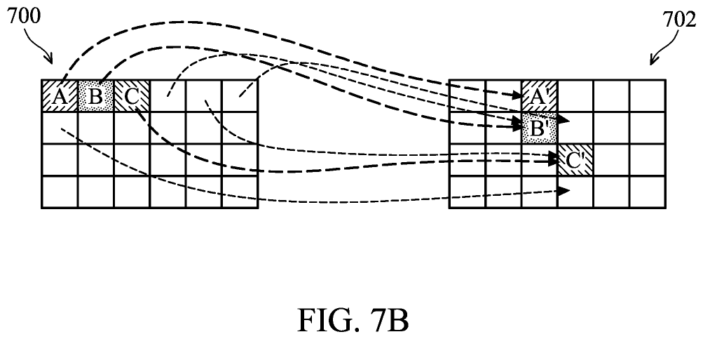

FIG. 7A is a schematic diagram of steps S600 and S602 in FIG. 6A in accordance with some embodiments of the present invention. As shown in FIG. 7A, the method for image alignment of the present invention receives a third image 700 from the first sensor, and receives a fourth image 702 from the second sensor. In some embodiments, the third image 700 is the image received according to the NIR spectrum, and the fourth image 702 is the image received according to the RGB spectrum, but the present invention is not limited thereto. If the third image 700 matches the first image received in the pre-calibration stage, the method for image alignment of the present invention generates a warping function 710 according to the pixel features in both the first image and the second image with the highest discrimination and the highest similarity in the pre-calibration stage. After that, the method for image alignment of the present invention input the third image 700 (or the fourth image 702) into the warping function 710 to perform image alignment between the third image 700 and the fourth image 702. That is, the method for image alignment of the present invention performs steps S600 and S602, as some embodiments of FIG. 7A, to finish the image alignment between the third image 700 and the fourth image 702 through the image-to-image conversion.

FIG. 7B is a schematic diagram of step S604 in FIG. 6B in accordance with some embodiments of the present invention. As shown in FIG. 7B, the method for image alignment of the present invention receives the third image 700 from the first sensor, and receives the fourth image 702 from the second sensor. In some embodiments, the third image 700 is the image received according to the NIR spectrum, and the fourth image 702 is the image received according to the RGB spectrum, but the present invention is not limited thereto. If the third image 700 matches the first image received in the pre-calibration stage, the method for image alignment of the present invention converts the position of each pixel in the third image 700 to the position of each pixel in the fourth image 702 through the first displacement vector based on the first feature correspondence between the first image and the second image in the pre-calibration stage to perform image alignment between the third image 700 and the fourth image 702. For example, in some embodiments of FIG. 7B, the pixel at position A in the third image 700 is converted into the pixel at position A′ in the fourth image 702, the pixel at position B in the third image 700 is converted into the pixel at position B′ in the fourth image 702, and the pixel at position C in the third image 700 is converted into the pixel at position C′ in the fourth image 702. That is, the method for image alignment of the present invention performs step S604, as some embodiments of FIG. 7B, to finish the image alignment between the third image 700 and the fourth image 702 through the pixel-to-pixel conversion.

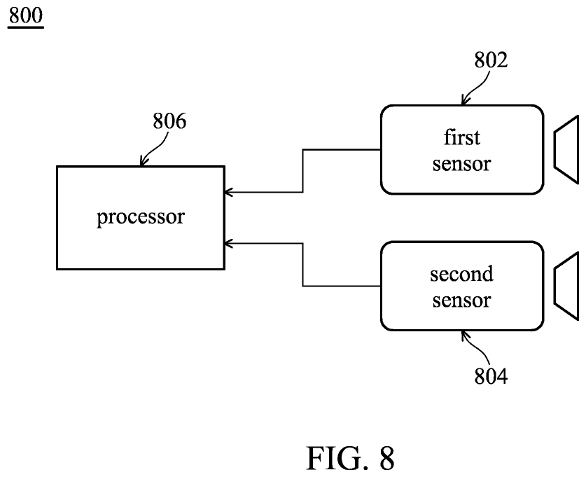

FIG. 8 is a schematic diagram of an electronic system 800 in accordance with some embodiments of the present invention. As shown in FIG. 8, the electronic system 800 includes a first sensor 802, a second sensor 804, and a processor 806. In some embodiments, the first sensor 802 is a NIR sensor. The second sensor 804 is a RGB sensor with a replaceable filter, but the present invention is not limited thereto. The replaceable filter is able to let NIR pass through, so that the NIR is received by the second sensor 804. In some embodiments, the first sensor 802 outputs a first image and a third image according to a first property. The second sensor 804 installs the replaceable filter to output a second image according to the first property. The second sensor 804 detaches the replaceable filter to output a fourth image according to the second property. The first property is different from the second property. In some embodiments, the first property represents a first spectrum range of the first image, and the second property represents a second spectrum range of the second image. That is, the first spectrum range of the first image is different from the second spectrum range of the second image. In some embodiments, the first spectrum range is the NIR spectrum, and the second spectrum range is the RGB spectrum, but the present invention is not limited thereto. In some embodiments, the processor 806 performs steps S100-S108 in FIG. 1. In some embodiments, more than two sensors could be implemented. For example, a third sensor with a replaceable filter to output a third image according to the first spectrum range is implemented, and the image alignment among the first, second and third sensors is performed based on the proposed methods mentioned above.

In some embodiments, if the third image does not match the first image received in the pre-calibration stage, the processor 806 performs steps S200, S202, S206, S208, and S210 in FIG. 2. If the third image matches the first image received in the pre-calibration stage, the processor 806 performs steps S200, S202, S204, and S108 in FIG. 2. In some embodiments, the processor 806 performs steps S300 and S302 in FIG. 3A and steps S400 and S402 in FIG. 4A no matter whether the third image matches the first image received in the pre-calibration stage or not. The processor 806 performs steps S304 and S306 in FIG. 3B and steps S404 and S406 in FIG. 4B only when the third image does not match the first image received in the pre-calibration stage. In some embodiments, the processor 806 performs steps S600 and S602 to finish the image alignment between the third image and the fourth image through the image-to-image conversion. In some embodiments, the processor 806 performs step S604 to finish the image alignment between the third image and the fourth image through the pixel-to-pixel conversion.

In some embodiments, the time at which the processor 608 receives the first image and the second image is earlier than the time at which the processor 608 receives the third image and the fourth image. In some embodiments, the processor 608 stores the first feature correspondence between the first image and the second image into a warping map. The warping map records the first displacement vector of each pixel between the first image and the second image. In some embodiments, the processor 608 performs image fusion on the third image and the fourth image after the image alignment to output a fusion image. In some embodiments, the processor 608 is the processor in an electronic device, such as a desktop, a laptop, a tablet, a smartphone, or a server, but the present invention is not limited thereto.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for image alignment, comprising:
receiving a first image with a first property from a first sensor;
receiving a second image with a second property from a second sensor, wherein the first property is similar to the second property;
calculating a first feature correspondence between the first image and the second image;
receiving a third image with a third property from the first sensor and a fourth image with a fourth property from the second image sensor, wherein the third property is different from the fourth property; and
performing image alignment on the third image and the fourth image based on the first feature correspondence between the first image and the second image.

2. The method as claimed in claim 1, wherein the first property represents a first spectrum range of the first image, and the second property represents a second spectrum range of the second image, wherein the second spectrum range is similar to the first spectrum range.

3. The method as claimed in claim 2, wherein the third property represents a third spectrum range of the third image, and the fourth property represents a fourth spectrum range of the fourth image, wherein the third spectrum range is similar to the first spectrum range and different from the fourth spectrum range.

4. The method as claimed in claim 3, wherein the first image and the second image are received earlier than the third image and the fourth image.

5. The method as claimed in claim 1, further comprising:
storing the first feature correspondence between the first image and the second image into a warping map.

6. The method as claimed in claim 5, wherein the warping map records a first displacement vector of each pixel between the first image and the second image.

7. The method as claimed in claim 3, further comprising:
comparing the third image with the first image to obtain a comparison result; and
determining whether to perform image alignment on the third image and the fourth image based on the first feature correspondence according to the comparison result.

8. The method as claimed in claim 7, wherein the comparison result indicates that the third image matches the first image, or the third image does not match the first image.

9. The method as claimed in claim 7, wherein if the third image does not match the first image, the method further comprises:
calculating a second feature correspondence between the third image and the fourth image; and
performing image alignment on the third image and the fourth image based on the second feature correspondence between the third image and the fourth image.

10. The method as claimed in claim 6, wherein the step of calculating the first feature correspondence between the first image and the second image comprises:
performing feature extraction on each pixel in the first image and the second image to obtain respective pixel features; and
performing feature matching between each pixel in the first image and each pixel in the second image to obtain the first displacement vector.

11. The method as claimed in claim 10, wherein the step of performing feature matching between each pixel in the first image and each pixel in the second image comprises:
searching for and recording a position of the pixel features in the first image corresponding to the pixel features with the highest similarity in the second image; and
generating the first displacement vector according to the position of the pixel features in the first image corresponding to the pixel features with the highest similarity in the second image.

12. The method as claimed in claim 10, wherein the pixel features comprise brightness, color, and texture.

13. The method as claimed in claim 10, wherein the step of performing image alignment on the third image and the fourth image based on the first feature correspondence between the first image and the second image comprises:
generating a warping function according to the pixel features in both the first image and the second image with the highest discrimination and the highest similarity; and
inputting the third image or the fourth image into the warping function to perform image alignment between the third image and the fourth image.

14. The method as claimed in claim 10, wherein the step of performing image alignment on the third image and the fourth image based on the first feature correspondence between the first image and the second image comprises:
converting the position of each pixel in the third image to the position of each pixel in the fourth image through the first displacement vector to perform image alignment between the third image and the fourth image.

15. The method as claimed in claim 9, further comprising:
storing the second feature correspondence between the third image and the fourth image into a warping map.

16. The method as claimed in claim 1, further comprising:
performing image fusion on the third image and the fourth image after the image alignment to output a fusion image.

17. An electronic system, comprising:
a first sensor, configured to output a first image and a third image according to a first property;
a second sensor, configured to output a second image according to the first property and output a fourth image according to a second property, wherein the second property is different from the first property;
a processor, configured to perform the following steps:
receiving the first image from the first sensor;
receiving the second image from the second sensor;
calculating a first feature correspondence between the first image and the second image;
receiving the third image from the first sensor and the fourth image from the second sensor; and
performing image alignment on the third image and the fourth image based on the first feature correspondence between the first image and the second image.

18. The electronic system as claimed in claim 17, wherein the time at which the processor receives the first image and the second image is earlier than the time at which the processor receives the third image and the fourth image.

19. The electronic system as claimed in claim 17, wherein the processor stores the first feature correspondence between the first image and the second image into a warping map.

20. The electronic system as claimed in claim 17, wherein the warping map records a first displacement vector of each pixel between the first image and the second image.
